(19) United States
(12) Patent Application Publication
(10) Pub. No.: US 2026/0051175 A1
(43) Pub. Date: Feb. 19, 2026

(54) SYSTEM AND METHOD FOR IDENTIFYING DISCREPANCIES BETWEEN WEAKLY CONJOINED VEHICLES

(71) Applicant: MOTOROLA SOLUTIONS, INC., CHICAGO, IL (US)

(72) Inventors: JAMES HOGLUND, DALLAS, TX (US); BARRY GRAVANTE, LYNNFIELD, MA (US); ZACHARY WEINGARTEN, SOMERVILLE, MA (US); ALEKSEY LIPCHIN, NEWTON, MA (US)

(21) Appl. No.: 18/804,785

(22) Filed: Aug. 14, 2024

(51) Int. Cl. G06V 20/54; G08B 13/00

(52) U.S. Cl. CPC G06V 20/54; G08B 13/00; G06V 2201/07; G06V 2201/08

(57) ABSTRACT

Techniques for identification of discrepancies between weakly conjoined vehicles is provided. A first transporting vehicle is identified at a first time. A transported vehicle associated with the first transporting vehicle is identified at the first time. It is determined, at a second time later than the first time, that the transported vehicle is associated with a second transporting vehicle. An alarm is raised indicating a discrepancy between the first transporting vehicle and the transported vehicle.

### BACKGROUND

Automatic License Plate Reader (ALPR) systems are becoming ubiquitous. An ALPR system generally includes a camera that is capable of capturing images of license plates. For example, license plates of vehicles traveling on a highway, entering a parking garage, passing through a toll booth, entering a restricted area, entering an access controlled area, etc. The ALPR systems may then perform Optical Character Recognition, or some other form of recognition, to extract the license plate number from the image. The cameras of ALPR systems may be fixed in position or mobile (e.g. installed in a police car, etc.).

Once the license plate number has been extracted, the license plate number can be used for any number of different reasons. For example, a database may store a list of license plates of cars that have been reported stolen. When an ALPR camera extracts a license plate number, the number can be compared against the database. If there is “a hit” indicating that the license plate is associated with a car that has been reported stolen, the ALPR system may raise an alert indicating that a stolen vehicle has possibly been identified.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is an example of several different types of weakly conjoined vehicles.

FIG. 2 is an example of ALPR being used to monitor weakly conjoined vehicles in an open road environment.

FIG. 3 is an example of ALPR being used to monitor weakly conjoined vehicles in an access controlled area.

FIG. 4 is an example flow diagram illustrating an implementation of the monitoring weakly conjoined vehicle techniques described herein.

FIG. 5 is an example of a device that may implement the monitoring weakly conjoined vehicle techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

There exists a class of vehicles that may be referred to as weakly conjoined vehicles. Weakly conjoined vehicles may be a combination of several different vehicles that are associated with each other in a non-permanent fashion. For example, consider a truck towing a trailer that is carrying a boat. There are three separate vehicles, the truck, the trailer, and the boat. There is not necessarily a permanent connection between the vehicles. A different truck could be connected to the trailer, a different boat could be placed on the trailer, or a different trailer entirely may be used.

Each of weakly conjoined vehicles may have an identifier. For example, both the pickup truck and the trailer will have license plates. A boat will likely have some identifying factors such as a name painted on the boat or some other unique identifier. As mentioned above, ALPR systems are available that can read license plate information. Similarly, ALPR systems could be configured to identify vehicle characteristics (e.g. name on a boat, make and model, color, etc.). For ease of description, this introduction will focus on the truck and trailer portion of the example weakly conjoined vehicles.

As mentioned above, APLR systems may be programmed such that when a license plate is detected, the plate can be compared against a database (e.g. stolen vehicle database) to determine if the vehicle associated with the license plate has been stolen. This same functionality may occur with weakly conjoined vehicles.

A problem may occur when none of the vehicles license plates are currently listed in a database (e.g. stolen vehicle database) yet a theft may have occurred. For example, consider a person who has a boat on a trailer parked in front of their house, not currently connected to a truck. A thief may connect the trailer to their own vehicle and drive off. Because the thief's vehicle is not listed as stolen, there would be no database record in a stolen vehicle database. Likewise, until the trailer is reported as stolen, there will be no record of the trailer in the stolen vehicle database. Thus there exists a period in time (between the theft and reporting of the theft) where ALPR is unhelpful in detecting the stolen vehicles.

The techniques described herein overcome these problems individually and collectively. An ALPR system may be used to detect vehicles that are weakly conjoined. A record may be created that includes the identifiers of the set of weakly conjoined vehicles. For example, in the present example of a truck and trailer, a record may be created that includes the license plate numbers of both the truck and the trailer.

At a later time, the ALPR system may detect one of the weakly conjoined vehicles that is conjoined with a different vehicle than when the record was initially created. For example, the ALPR system may detect the license plate of the trailer, but based on the previously created record, identify that the trailer is now connected to a different truck. Although not dispositive, this may be an indication that the trailer has been stolen, but has not been reported stolen yet. Based on the discrepancy between the originally detected weakly conjoined vehicles and the currently detected weakly conjoined vehicles, an alert may be raised indicating that further investigation is necessary.

The techniques described herein are not limited to cases where the weakly conjoined vehicles have license plates. For example, in the case of a boat on a trailer, the boat may have identifying characteristics, such as a name. The name may be included in the record that contains the license plates of the truck and trailer. If, later, the boat is identified as being associated with a different truck and/or trailer, this may be an indication that the boat has been stolen. An alert may be raised and the situation further investigated (e.g. send an alert to law enforcement to pull over the weakly conjoined vehicle and verify there is nothing wrong.).

Although the example above was in terms of a truck, trailer, and boat, the techniques described herein are not so limited. Additional examples of types of weakly conjoined vehicles are described below. In addition, the detection of discrepancies within weakly conjoined vehicles may be used in combination with an access control system to prevent theft. Such a use case is described in further detail below.

A method for identification of discrepancies between weakly conjoined vehicles is provided. The method includes identifying a first transporting vehicle, at a first time. The method also includes identifying a transported vehicle associated with the first transporting vehicle, at the first time. The method also includes determining, at a second time later than the first time, that the transported vehicle is associated with a second transporting vehicle. The method also includes raising an alarm indicating a discrepancy between the first transporting vehicle and the transported vehicle.

In one aspect, identifying the transported vehicle further comprises identifying markings on the transported vehicle. In one aspect, identifying the transported vehicle further comprises identifying markings of a cargo carried by the transported vehicle.

A system for identification of discrepancies between weakly conjoined vehicles is provided. The system includes a processor and a memory coupled to the processor. The memory contains thereon a set of instructions that cause the processor to identify a first transporting vehicle, at a first time. The instructions also cause the processor to identify a transported vehicle associated with the first transporting vehicle, at the first time. The instructions also cause the processor to determine, at a second time later than the first time, that the transported vehicle is associated with a second transporting vehicle. The instructions also cause the processor to raise an alarm indicating a discrepancy between the first transporting vehicle and the transported vehicle.

A non-transitory processor readable medium containing thereon a set of instructions for identification of discrepancies between weakly conjoined vehicles is provided. The instructions, when executed by a processor cause the processor to identify a first transporting vehicle, at a first time. The instructions also cause the processor to identify a transported vehicle associated with the first transporting vehicle, at the first time. The instructions also cause the processor to determine, at a second time later than the first time, that the transported vehicle is associated with a second transporting vehicle. The instructions also cause the processor to raise an alarm indicating a discrepancy between the first transporting vehicle and the transported vehicle.

In one aspect, identifying the transported vehicle further comprises instructions to identify markings on the transported vehicle. In one aspect, identifying the transported vehicle further comprises instructions to identify markings of a cargo carried by the transported vehicle.

In one aspect, the first time is upon entry to a geofenced area and the second time is upon exit of the geofenced area. In one aspect, the cargo carried by the transported vehicle is at least one of a watercraft, an all-terrain vehicle, and a motorcycle. In one aspect, the transported vehicle is an automobile being towed by the first transporting vehicle. In one aspect, the transported vehicle is a trailer being towed by the first transporting vehicle.

Further advantages and features consistent with this disclosure will be set forth in the following detailed description, with reference to the figures.

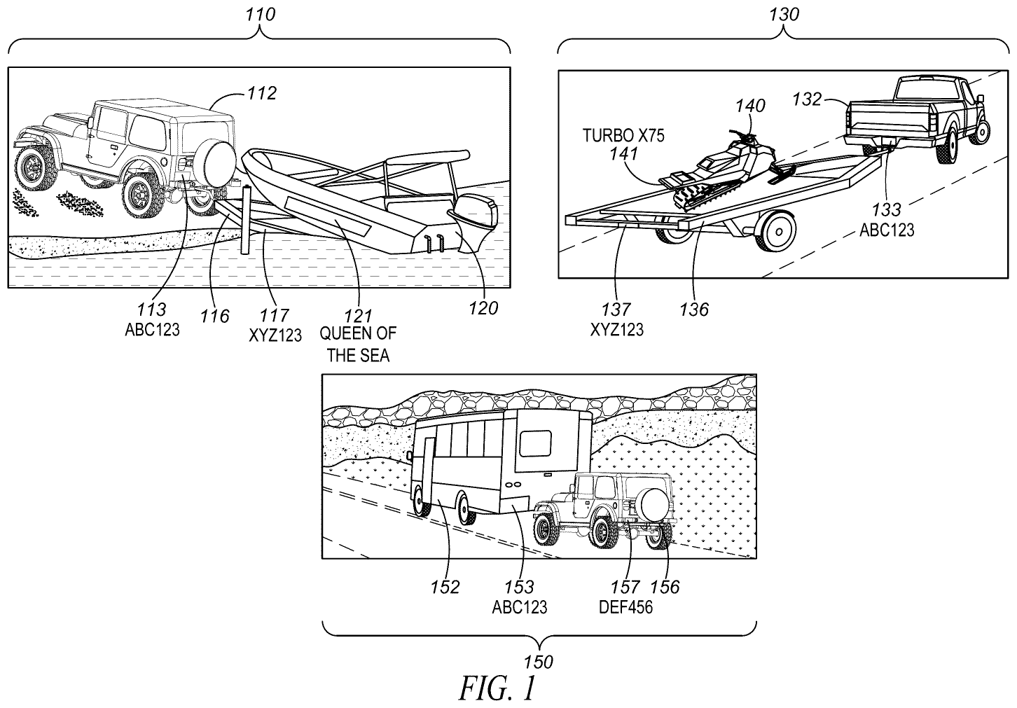

FIG. 1 is an example of several different types of weakly conjoined vehicles. For purposes of this description, certain terminology will be used when describing a set of weakly conjoined vehicles. A transporting vehicle is the vehicle within the set of weakly conjoined vehicles that provides propulsion power to the set of weakly conjoined vehicles. For example, a truck or motorhome that is towing a trailer may be the transporting vehicle. A transported vehicle is a vehicle that is being propelled by a transporting vehicle. For example, in the case where a trailer is being towed by a vehicle, the trailer is referred to as the transported vehicle as it is not propelling itself. It should be noted that a transported vehicle may be capable of propelling itself under the correct conditions. Examples of such situations are described below. What should be understood is at the time of detection, the transported vehicle is not operating under its own propulsion.

There is yet a third category within the set of weakly conjoined vehicles that may be referred to as cargo of a transported vehicle. For example, a transporting vehicle may be towing a transported vehicle, such as a trailer. That trailer may have a cargo (e.g. boat, snow machine, etc.) that is detachably connected to the transported vehicle. In many cases, the cargo of a transported vehicle may not have a standardized identification scheme (e.g. a boat or ATV may not have a license plate, etc.). In such cases, cargo of a transported vehicle may be identified by other means, which are described below.

For example, weakly conjoined vehicles 110 may include a transporting vehicle 112. The transporting vehicle may include an identifier such as a license plate 113. The use of ALPR detection to identify a license plate is well known. Because the vehicle 112 is providing propulsion to the weakly conjoined set of vehicles, vehicle 112 is referred to as the transporting vehicle. The weakly conjoined vehicles 110 may also include a trailer 116 that is connected to the transporting vehicle 112. As such, the trailer 116 may be considered a transported vehicle, because it is not operating under its own propulsion, which is provided by the transporting vehicle. The trailer 116 may include an identifier such as a license plate 117.

The weakly conjoined vehicles 110 may also include a boat 120 that is carried by the transported vehicle 116 (e.g. the trailer). Because the boat 120 is being carried by the transported vehicle 116, the boat may be considered cargo. In many cases, the cargo 120 of a transported vehicle may not have a standardized identifier. For example, the boat 120 may not have an equivalent of a license plate number. However, there may be other identifying characteristics. For example, in many cases, boats may have a name 121 painted onto them. Such an identifier can be used to later identify the cargo 120 and ensure there are no discrepancies, which will be described in further detail below. It should be understood that techniques for extracting things, such as a name, from a vehicle are known. The techniques described herein are not dependent on any particular form of extracting identifying information from transported cargo.

Weakly conjoined vehicles 130 may include a transporting vehicle 132 which includes an identifying license plate 133. Just as above, the transporting vehicle may be coupled to a transported vehicle 136, which has a license plate 137. However, in the case of weakly conjoined vehicles 130, the transported cargo 140 may not have an identifier such as a license plate or name. In such cases, the system may identify the cargo 140 using other identifying characteristics. For example, the system may determine the cargo is a snow machine and that the snow machine's color is red. The system may also be able to determine the model 141 of the snow machine based on markings, even though those markings may not be sufficient to individually identify the cargo, as would be the case with a license plate. In some implementations, a machine learning classifier may be used to identify the cargo. What should be understood is that the cargo 140 being transported can be identified with enough accuracy to later determine a discrepancy in the weakly conjoined vehicles, as will be described in further detail below.

Weakly conjoined vehicles 150 describe a set of vehicles where both the transported and transporting vehicle are capable of providing propulsion. Weakly conjoined vehicles 150 may include a motorhome 152, with associated license plate 153. In this example vehicle set, the transported vehicle 156, having license plate 157, is actually a vehicle (e.g. a car being towed) that is capable of propelling itself. However, since the vehicle 156 is currently being towed by a transporting vehicle 152, the vehicle 156 is considered a transported vehicle.

It should be understood that the examples provided in FIG. 1 are just that, examples. There can be any number of other weakly conjoined vehicle combinations. For example, a truck towing a trailer whose cargo is a classic car, in such a case, all three vehicles may have license plates. As yet another example, the transported vehicle may be eliminated. For example, an all-terrain vehicle may be placed in the back of a pickup truck (as opposed to on a trailer). In such cases, the cargo would be carried by the transporting vehicle. What should be understood is that the system is able to create a record of the vehicles that make up a set of weakly conjoined vehicles and then detect, later, if there is a discrepancy in the individual vehicles that are making up the set of weakly conjoined vehicles.

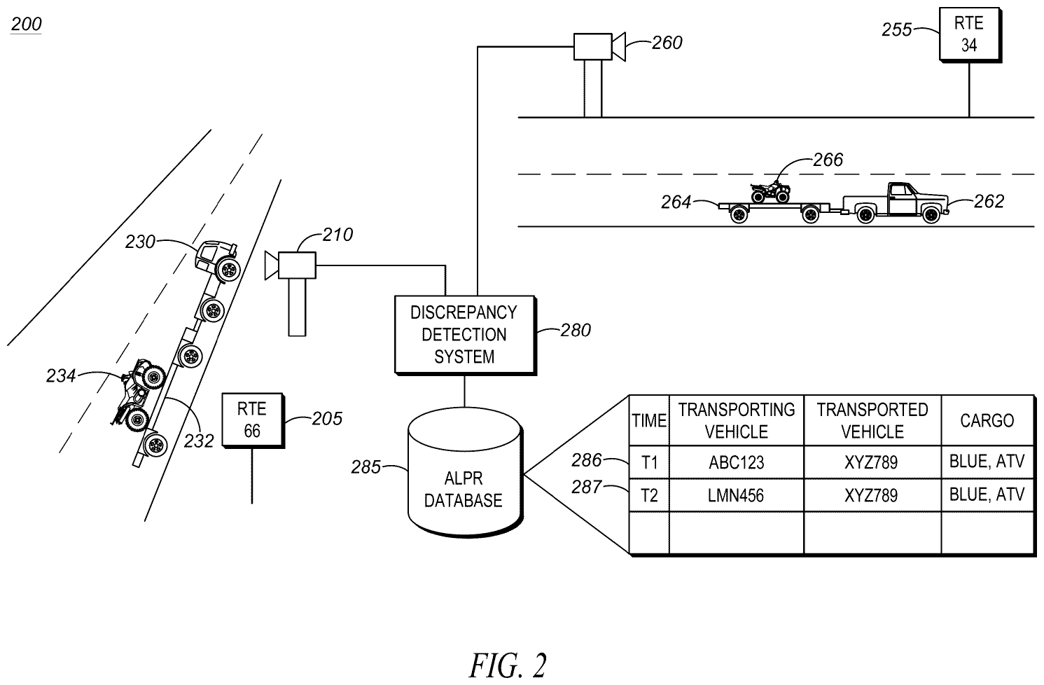

FIG. 2 is an example of ALPR being used to monitor weakly conjoined vehicles in an open road environment. Environment 200 may include two separate roads 205, 255 labeled as Route 66 and Route 34 respectively. It should be understood that the selection of two roads is for ease of description only. Each of the routes may be equipped with ALPR cameras 210, 260. The ALPR cameras are able to detect and identify license plates, as well as other identifying characteristics of weakly conjoined vehicles (e.g. boat names, makes and model of cargo, color of cargo, etc.).

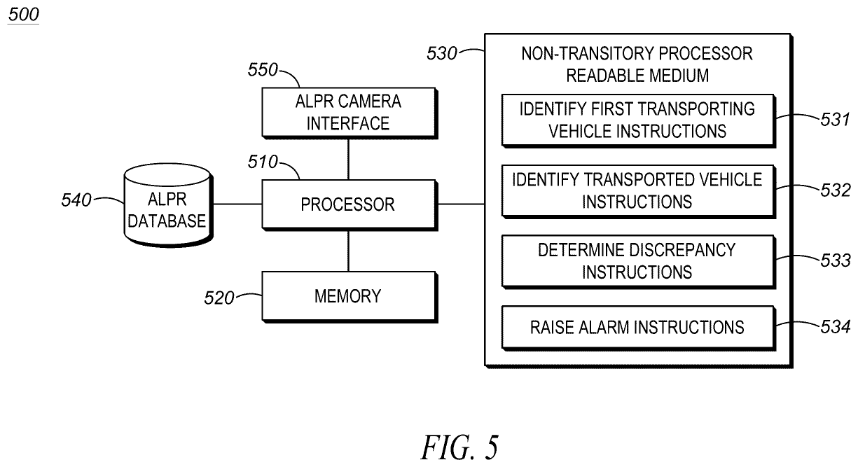

The environment 200 also include a discrepancy detection system 280. Example hardware that may implement the discrepancy detection system is described with respect to FIG. 5. The discrepancy detection system may be coupled to the ALPR cameras 210, 260, as well as to a database 285 that may store associations between the vehicles in a weakly conjoined set of vehicles. For example, the license plate of a transporting and transported vehicle may be stored, along with identifying characteristics of any cargo that is being transported. In addition, a time stamp of when such as association was created may be stored.

In one example operation, a transporting vehicle 230 having license plate ABC123 may be towing a transported vehicle 232 having a license plate of XYZ789. The trailer may be carrying an all-terrain vehicle (ATV) 234 as cargo. For purposes of this example operation, there is no identifier, such as a license plate, on the ATV. The set of weakly conjoined vehicles 230, 232, 234 may pass ALPR camera 210 at a certain time, which will be referred to as T1. The ALPR camera 210 may detect the license plates of the transporting and transported vehicles. The ALPR camera may also capture characteristics of the cargo 234, such as the make, model, and color of the cargo.

The ALPR camera 210 may determine that based on the proximity of the vehicles, that this set of vehicles is a weakly conjoined set of vehicles. There are many known techniques for determining a set of vehicles mat be conjoined (e.g. proximity of the vehicles to one another, tracking the speed of the vehicles indicates they are moving at the exact same speed, vehicles moving in the same direction simultaneously, etc.). What should be understood is that there are known techniques to determine a set of vehicles is currently connected to each other. The techniques described herein are not dependent on any particular technique to determine that a set of vehicles is a weakly conjoined set of vehicles.

The ALPR camera 210 may then send the identifying information captured to the discrepancy detection system 280. The discrepancy detection system may create a record 286 within the database 285 to store this association. As shown, record 286 may indicate that at time T1, a transporting vehicle with license plate ABC123 was seen associated with a transported vehicle having license plate XYZ789. The transported vehicle contained thereon cargo which was detected as a blue ATV. In this example use case, there is no specific identifier associated with the cargo, but enough information can be captured to obtain a general identification of the cargo.

At a later time T2, an ALPR camera 260 may detect a transporting vehicle 262 with license plate LMN456. The Transporting vehicle may be associated with a transported vehicle 264 having license plate XYZ789. The transported vehicle may be carrying cargo 266 identified as a blue ATV. Just as above, the ALPR camera 260 may then send the identifying information captured to the discrepancy detection system 280. The discrepancy detection system may create a record 287 within database 285 to store this information. As shown, record 287 may indicate that at time T2, a transporting vehicle with license plate LMN456 was seen associated with a transported vehicle having license plate XYZ789. The transported vehicle contained thereon cargo which was detected as a blue ATV.

The discrepancy detection system 280 may then compare records stored in database 285 to determine if there are any discrepancies between the vehicles included in the set of weakly conjoined vehicles. In this example, a comparison of records 286, 287 indicates that the transported vehicle having license plate XYZ789 carrying a blue ATV was initially associated with a transporting vehicle having license plate ABC123. However, at time T2, that same transported vehicle is now associated with a completely different transporting vehicle, which has a license plate of LMN456.

Such a discrepancy may mean nothing. For example, the owner of the vehicle, trailer, and ATV may have multiple transporting vehicles, and has simply decided to use a different vehicle to transport the ATV. However, it is also possible that someone has stolen the transported vehicle and cargo (e.g. trailer and ATV) by connecting the trailer to his own transporting vehicle. In response to such a detection, the discrepancy detection system may raise an alarm indicating the discrepancy. For example, just as when an ALPR system detects a license plate listed as stolen and sends that information to local law enforcement, a similar alarm with respect to the discrepancy can be sent. In some cases, this may prompt a law enforcement response to further investigate (e.g. pull the weakly conjoined set of vehicles over and conduct an investigation to determine if theft has taken place, etc.).

Although FIG. 2 has been described with respect to two separate ALPR cameras covering different locations, it should be understood that the techniques described herein are not so limited. For example, the discrepancy detection system 280 may receive information related to a weakly conjoined set of vehicles from ALPR camera 210. At a later time, a new set of information may be received from ALPR camera 210 that has discrepancies from what was previously provided. Such discrepancies would still cause an alarm to be raised, as the discrepancy is based on the data captured, not the location from which it was captured.

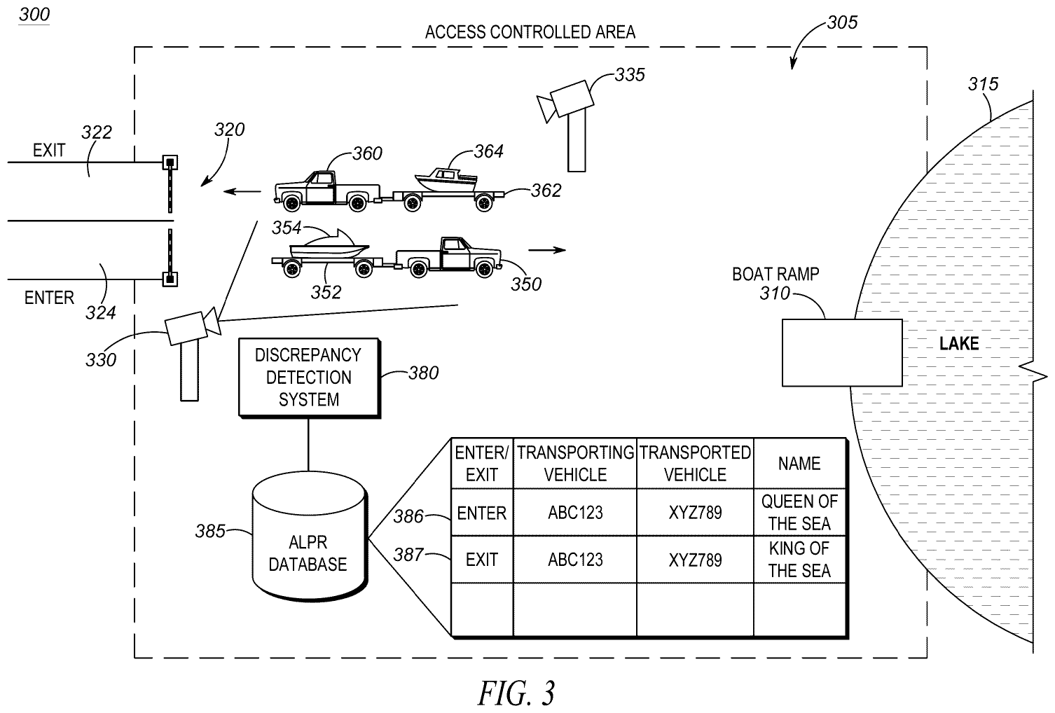

FIG. 3 is an example of ALPR being used to monitor weakly conjoined vehicles in an access controlled area. Environment 300 may include an access controlled area 305. An access controlled area is an area in which ingress and/or egress is not permitted freely, but rather requires some type of authentication to prove that ingress and/or egress by a particular entity is permitted. In the example shown in FIG. 3, the access controlled area may be a boat ramp 310 (e.g. where boats are launched into/retrieved from a body of water such as a lake 315).

The access controlled area 305 may be equipped with a barrier, such as a gate 320 at the exit 322 of the access controlled area 305. The gate may prevent vehicles, such as weakly conjoined vehicles, from leaving the access controlled area unless authorized. Although not shown, it should be understood that the access controlled area could also include a similar barrier on the entrance to ensure that only authorized vehicles are able to enter the access controlled area.

The access controlled area 305 may include an ALPR camera 330 that monitors weakly conjoined vehicles as they enter the access controlled area via the entrance 324. The access controlled area may also include an ALPR camera 335 that monitors weakly conjoined vehicles as they exit the access controlled area via the exit 322. As should be clear, the gate 320 prevents weakly conjoined vehicles from departing the access controlled area unless authorized, as will be described in further detail below.

In operation, a transporting vehicle 350, such as a truck, with license plate number ABC123 may be coupled to a transported vehicle 352, such as a boat trailer, having license plate number XYZ789. The transported vehicle may be carrying a boat 354 as cargo. The boat itself may not have an identifier such as a license plate, but may be associated with a name or other identifying information. For example, the boat may have the name “Queen of the Sea” painted on it. Upon entry of the weakly conjoined vehicles 350, 352, 354, the ALPR camera 330 may identify the weakly conjoined vehicles and send such information to a discrepancy detection system 380 that is coupled to a database 385. The discrepancy detection system and database are similar to those described with respect to FIG. 2, and the description will not be repeated here.

The discrepancy detection system 380 may then create a record 386 in the database 385 identifying the weakly conjoined vehicles. In this example, the direction of travel is the weakly conjoined vehicles are entering the access controlled area 305. The transporting vehicle 350 has a license plate of ABC123 and the transported vehicle 352 has a license plate of XYZ789. The cargo 354 (e.g. the boat) is associated with the name “Queen of the Sea.” Thus record 386 describes the set of vehicles that make up the weakly conjoined vehicle set as it entered the restricted area.

At a later point in time, the ALPR camera 335 may detect a transporting vehicle 360 attempting to exit the access controlled area 305. The transporting vehicle may be blocked from exiting the access controlled area by the gate 320, until such time as the discrepancy detection system 380 is able to ensure there are no discrepancies in the set of vehicles forming the weakly conjoined set of vehicles.

For example, transporting vehicle 360 may have a vehicle license plate of ABC123. The transporting vehicle may be coupled to a transported vehicle 362 (e.g. a boat trailer) that is carrying cargo 364 (e.g. a boat). The boat may have a name, for example, “King of the Sea.” The ALPR camera 335 may send this information to the discrepancy detection system 380, which in turn may create an association record 387 in the database 385. In this example, the direction of travel is that the weakly conjoined set of vehicles is exiting the restricted area. The transporting vehicle identifier is ABC123 and the transported vehicle identifier is XYZ789. However, in this case, the name on the cargo 364 is detected as “King of the Sea.”

As should be clear, there is a discrepancy between the weakly conjoined vehicle as it entered the access controlled area 305 and when it was attempting to leave. When entering the access controlled area the cargo was a boat named “Queen of the Sea” and while exiting the cargo was a boat named “King of the Sea” indicating that someone is attempting to leave with cargo different than they arrived with (e.g. potentially attempting to steal the boat named “King of the Sea”). The access control gate 320 may remain closed, preventing the exit of the transporting vehicle 360 until it can be determined why the transporting vehicle is attempting to leave the access controlled area with different cargo than which with it arrived.

Although the example presented above was described in terms of discrepancies between the cargo and the transporting/transported vehicle, it should be understood that the techniques described herein are not so limited. Any discrepancy may cause further investigation. For example, if a transporting vehicle arrives with a transported vehicle having a license plate of XYZ789 but later attempts to leave with a transported vehicle having a license plate of LMN456, this may indicate an attempt to steal the transported vehicle (e.g. the trailer). What should be understood is that discrepancies between vehicles making up a set of weakly conjoined vehicles are identified and further investigative action may be triggered by raising an alarm to appropriate personnel.

Although the use cases described with respect to FIGS. 2 and 3 are described in terms of identifying possible theft of weakly conjoined vehicles, it should be understood that the techniques described herein are not so limited. For example, in the case of a watercraft such as a boat, the association may be useful in tracking down an owner of the watercraft. For example, if a watercraft is found abandoned in a body of water, a records search could be performed to determine the associated transporting vehicle. The license plate of the identified transporting vehicle will be associated with a registered owner. As such, this provides at least a starting point to identify the owner of the watercraft.

In addition, the association details may be useful when trying to identify watercraft that may still be out on the water. As described above, records may be created when a set of weakly conjoined vehicles enters an area such as a boat ramp. If there is a record of the weakly conjoined vehicles, including the boat, entering the boat ramp, but no record of the boat leaving the boat ramp, it can be inferred that the boat itself is still in the water. Such information may be useful when it is necessary to identify all watercraft currently on the water (e.g. inclement weather approaching, evacuation required, etc.).

The techniques described herein may also be used as an aid to help track down the owners of transported vehicles or cargo that are behaving badly. For example, an operator of a boat may be operating the craft in an unsafe manner (e.g. high speed in no wake zone, drinking alcohol while operating, etc.). An identifier of the boat (e.g. a name, etc.) may not be easily correlated with the owner of the boat. However, by looking at the database, it may be determined which transporting vehicle is associated with the boat, and a license plate of the transporting vehicle identified. As a license plate is generally associated with a registered owner, the registered owner of the transporting vehicle may be contacted. Although this may not provide a final determination that the operator of the boat was the registered owner of the transporting vehicle, it at least provides some information that would be useful to begin an investigation.

Although the previous examples have been presented with respect to watercraft, such as boats, it should be understood that the techniques could be applicable to any other type of vehicles. For example, motorcycles, snow machines, race cars, campers, recreational vehicles, etc.

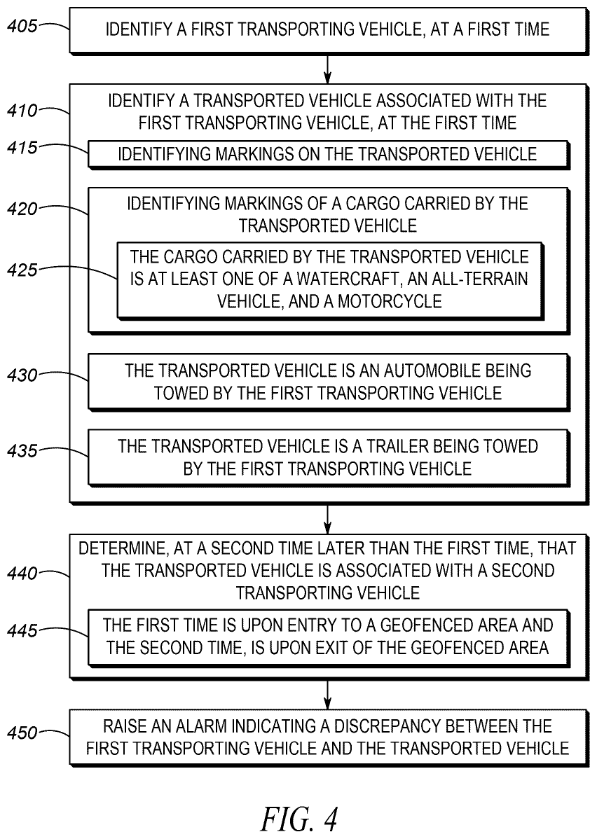

FIG. 4 is an example flow diagram 400 illustrating an implementation of the monitoring weakly conjoined vehicle techniques described herein. In block 405, a first transporting vehicle is identified at a first time. As explained above, a transporting vehicle is a vehicle that, in general, provides propulsion to a set of weakly conjoined vehicles. The transporting vehicle can include vehicles such as cars, trucks, motorhomes, etc. In general, any vehicle capable of causing other vehicles in the set of weakly conjoined vehicles to move may be called a transporting vehicle.

In block 410, a transported vehicle associated with the first transporting vehicle at the first time is identified. A transported vehicle is a vehicle that is being propelled by the transporting vehicle. For example, the transported vehicle may be a trailer attached to a transporting vehicle, such as a truck. The transported vehicle may, in some cases, also be capable of being a transporting vehicle. For example, a vehicle capable of self-propulsion, such as a car, may be towed by a vehicle such as a motorhome. In such cases, the car would be considered a transported vehicle, as it would not be currently providing its own propulsion.

The fact that the identification of the first transporting vehicle and the transported vehicle occurs at a first time may allow an initial association between the vehicles to be created. In other words, it is known that at the first time, both of the vehicles were currently weakly conjoined. As will become clear below, if at a later time the association no longer holds true, this may indicate a discrepancy in the set of weakly conjoined vehicles.

In block 415, identifying the transported vehicle further comprises identifying markings on the transported vehicle. In some cases, the transported vehicle may not necessarily include an identifier, such as a license plate. For example, an ATV in the back of a pickup truck may be considered a transported vehicle, but would not necessarily have a license plate. In such cases, identifiers may include a make/model of the transported vehicle, a description (e.g. color, etc.), a type of vehicle, etc. Although such identifiers may not be able to individually identify a transported vehicle, as would a license plate, such information would still be sufficient to determine when a discrepancy between the associations of weakly conjoined vehicles is identified.

In block 420, identifying the transported vehicle further comprises identifying markings of a cargo carried by the transported vehicle. As described above, a transported vehicle is often a vehicle such as a trailer. A trailer may be loaded with cargo. For example, cargo may include vehicles such as boats, ATVs, snow machines, etc. Cargo may generally not include individual identifiers such as license plates. As above, identifiers may include a make/model of the transported vehicle, a description (e.g. color, etc.), a type of vehicle, etc. In some cases (e.g. a boat), the cargo may include a name as an identifying marking.

In block 425, the cargo carried by the transported vehicle is one of a watercraft, an all-terrain vehicle, and a motorcycle. Although the techniques described herein are not limited to these types of cargo, these are often the types of vehicles that are moved as part of a set of weakly conjoined vehicles. For example, watercraft cannot be moved along roadways, and must be transported via trailer. In many jurisdictions, all-terrain vehicles are not permitted on public roadways. Although motorcycles may be moved on public roadways, depending on factors such as length of the trip and weather conditions, it may be unpleasant to drive a motorcycle. As such, these types of vehicles are often moved on trailers, and hence may be a greater risk of being stolen.

In block 430, the transported vehicle is an automobile being towed by the first transporting vehicle. As mentioned above, the transported vehicle, in some cases, may be a vehicle itself that is capable of propelling itself down a road. One common example of such a situation is when a vehicle, such as a motorhome, is towing a car. Even though the car itself is capable of propelling itself, while it is being towed it is a transported vehicle. What should be understood is that a transported vehicle is one that is currently being propelled by a transporting vehicle, regardless of if it is capable of propelling itself.

In block 435, the transported vehicle is a trailer being towed by the first transporting vehicle. One of the most common cases of weakly conjoined vehicles is when the transported vehicle is a trailer carrying other vehicles (e.g. boats, ATVs, etc.). However it should be understood that even though a trailer is a very common transported vehicle, the techniques described herein are not limited to trailers as the only type of transported vehicle. For example, in some cases, a transported vehicle may be a vehicle such as an ATV placed directly on the transporting vehicle (e.g. an ATV in the bed of a pickup truck).

In block 440, at a second time later than the first time, it is determined that the transported vehicle is associated with a second transporting vehicle. In other words, at the first time, the transported vehicle was associated with a first transporting vehicle and at a second time, the transported vehicle is no longer associated with the first transporting vehicle, but is now associated with a second transporting vehicle. In the simplest of cases, when the transported vehicle is a trailer, it means the trailer has been disconnected from one propulsion vehicle and is now attached to a different propulsion vehicle. Although this is not determinative that nefarious activity (e.g. theft, etc.) is occurring, it raises enough concern that the situation may need to be further investigated.

In block 445, the first time is upon entry to a geofenced area and the second time is upon exit of the geofenced area. As described above, with respect to FIG. 3, the techniques described herein may be utilized when trying to protect an access controlled area. An access controlled area may also be referred to as a geofenced area. In some implementations, the first time is construed as when the weakly conjoined vehicles attempt to enter the geofenced (e.g. access controlled areas) and the second time is when the weakly conjoined vehicles attempt to leave the geofenced area.

In block 450, an alarm is raised indicating a discrepancy between the first transporting vehicle and the transported vehicle. In other words, when it is determined that the transported vehicle is no longer associated with the transporting vehicle it was originally associated with, an alarm is raised. Although such a discrepancy is not dispositive that the transported vehicle is being stolen, it raises a sufficient level of concern that further investigation may be warranted. The alarm that is raised may be sent to an agency, such as a law enforcement agency, to further investigate the discrepancy. For example, a law enforcement agent may be dispatched to the weakly conjoined vehicles location to interrogate the vehicle operator to clarify why the discrepancy exists. In the case where it turns out a theft has actually occurred, the vehicle operator may be detained or arrested.

FIG. 5 is an example of a device 500 that may implement the identifying discrepancies between weakly conjoined vehicles techniques described herein. It should be understood that FIG. 5 represents one example implementation of a computing device that utilizes the techniques described herein. Although only a single processor is shown, it would be readily understood that a person of skill in the art would recognize that distributed implementations are also possible. For example, the various pieces of functionality described above (e.g. identifying transporting, transported, vehicles, identifying cargo, identifying discrepancies, etc.) could be implemented on multiple devices that are communicatively coupled. FIG. 5 is not intended to imply that all the functionality described above must be implemented on a single device.

Device 500 may include processor 510, memory 520, non-transitory processor readable medium 530, ALPR database 540, and ALPR camera interface 550.

Processor 510 may be coupled to memory 520. Memory 520 may store a set of instructions that when executed by processor 510 cause processor 510 to implement the techniques described herein. Processor 510 may cause memory 520 to load a set of processor executable instructions from non-transitory processor readable medium 530. Non-transitory processor readable medium 530 may contain a set of instructions thereon that when executed by processor 510 cause the processor to implement the various techniques described herein.

For example, medium 530 may include identify first transporting vehicle instructions 531. The identify first transporting vehicle instructions 531 may cause the processor to utilize the ALPR camera interface 550 to get information from an ALPR camera, such as a license plate, for a first transporting vehicle. The identify first transporting vehicle instructions 531 are described throughout this description generally, including places such as the description of block 405.

The medium 530 may include identify transported vehicle instructions 532. The identify transported vehicle instructions 532 may cause the processor to utilize the ALPR camera interface 550 to get information from an ALPR camera for a transported vehicle. The information may include license plate information, cargo description information, transported vehicle description information, etc. The identify transported vehicle instructions 532 are described throughout this description generally, including places such as the description of blocks 410-435.

The medium 530 may include determine discrepancy instructions 533. The determine discrepancy instructions 533 may cause the processor to compare the information related to the first transporting vehicle with information of a second transporting vehicle that may have been received via the ALPR camera interface 550. The determine discrepancy instructions 533 may cause the processor to determine that a transported vehicle is associated with two different transporting vehicles at different times. The determine discrepancy instructions 533 are described throughout this description generally, including places such as the description of blocks 440 and 445.

The medium 530 may include raise alarm instructions 534. The raise alarm instructions 534 may cause the processor to raise an alarm whenever there is a discrepancy detected between transporting and transported vehicles. In some cases, the alarm may be raised to a law enforcement agency to investigate the source of the discrepancy. The raise alarm instructions 534 are described throughout this description generally, including places such as the description of block 450.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot implement an automatic license plate recognition system that constantly monitors weakly conjoined vehicles to determine associations amongst those vehicles and identifies discrepancies between the associations, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for identification of discrepancies between weakly conjoined vehicles comprising:
identifying a first transporting vehicle, at a first time;
identifying a transported vehicle associated with the first transporting vehicle, at the first time;
determining, at a second time later than the first time, that the transported vehicle is associated with a second transporting vehicle; and
raising an alarm indicating a discrepancy between the first transporting vehicle and the transported vehicle.

2. The method of claim 1 wherein the first time is upon entry to a geofenced area and the second time is upon exit of the geofenced area.

3. The method of claim 1 wherein identifying the transported vehicle further comprises:
identifying markings on the transported vehicle.

4. The method of claim 1 wherein identifying the transported vehicle further comprises:
identifying markings of a cargo carried by the transported vehicle.

5. The method of claim 4 wherein the cargo carried by the transported vehicle is at least one of a watercraft, an all-terrain vehicle, and a motorcycle.

6. The method of claim 1 wherein the transported vehicle is an automobile being towed by the first transporting vehicle.

7. The method of claim 1 wherein the transported vehicle is a trailer being towed by the first transporting vehicle.

8. A system for identification of discrepancies between weakly conjoined vehicles comprising:
a processor; and
a memory coupled to the processor, the memory containing thereon a set of instructions that when executed by the processor cause the processor to:
identify a first transporting vehicle, at a first time;
identify a transported vehicle associated with the first transporting vehicle, at the first time;
determine, at a second time later than the first time, that the transported vehicle is associated with a second transporting vehicle; and
raise an alarm indicating a discrepancy between the first transporting vehicle and the transported vehicle.

9. The system of claim 8 wherein the first time is upon entry to a geofenced area and the second time is upon exit of the geofenced area.

10. The system of claim 8 wherein identifying the transported vehicle further comprises instructions to:
identify markings on the transported vehicle.

11. The system of claim 8 wherein identifying the transported vehicle further comprises instructions to:
identify markings of a cargo carried by the transported vehicle.

12. The system of claim 11 wherein the cargo carried by the transported vehicle is at least one of a watercraft, an all-terrain vehicle, and a motorcycle.

13. The system of claim 8 wherein the transported vehicle is an automobile being towed by the first transporting vehicle.

14. The system of claim 8 wherein the transported vehicle is a trailer being towed by the first transporting vehicle.

15. A non-transitory processor readable medium containing thereon a set of instructions for identification of discrepancies between weakly conjoined vehicles which when executed by a processor cause the processor to:
identify a first transporting vehicle, at a first time;
identify a transported vehicle associated with the first transporting vehicle, at the first time;
determine, at a second time later than the first time, that the transported vehicle is associated with a second transporting vehicle; and
raise an alarm indicating a discrepancy between the first transporting vehicle and the transported vehicle.

16. The non-transitory processor readable medium of claim 15 wherein the first time is upon entry to a geofenced area and the second time is upon exit of the geofenced area.

17. The non-transitory processor readable medium of claim 15 wherein identifying the transported vehicle further comprises instructions to:
identify markings on the transported vehicle.

18. The non-transitory processor readable medium of claim 15 wherein identifying the transported vehicle further comprises instructions to:
identify markings of a cargo carried by the transported vehicle.

19. The non-transitory processor readable medium of claim 18 wherein the cargo carried by the transported vehicle is at least one of a watercraft, an all-terrain vehicle, and a motorcycle.

20. The non-transitory processor readable medium of claim 15 wherein the transported vehicle is a trailer being towed by the first transporting vehicle.
